(19) United States
(12) Patent Application Publication
(10) Pub. No.: US 2005/0060376 A1
(43) Pub. Date: Mar. 17, 2005

(54) Secure computer telephony integration access

(76) Inventor: Neal P. Moran, Camberley (GB)

Correspondence Address: BUCKLEY, MASCHOFF, TALWALKAR LLC, 5 ELM STREET, NEW CANAAN, CT, 06840, US

(21) Appl. No.: 10/660,876

(22) Filed: Sep. 12, 2003

(51) Int. Cl. G06F 15/16

(52) U.S. Cl. 709/206

(57) ABSTRACT

A system, an apparatus, and a method for securely accessing a computer telephony integration device over a public network.

### BACKGROUND

Computer Telephony Integration (CTI) systems are systems that utilize CTI software, usually running in servers, to manage telephone calls. CTI systems are commonly used by businesses in connection with Private Branch Exchanges (PBXs) to process calls in such a way as to enhance business environments. For example, a telephone number from which an incoming telephone call originated may be used to authenticate the caller and permit access to the CTI system by confirming that the originating telephone number exists in a user database. CTI systems may be used to reroute outbound calls made by a pre-dialer to a telemarketer when a telephone call is determined to have been answered by a person or may receive and route facsimile messages to an appropriate facsimile machine. A CTI system may also incorporate such things as Interactive Voice Response (IVR) with which a caller voice pattern or command may be recognized for such things as authentication and call routing. The CTI system may furthermore manage voice and video conferencing.

### BRIEF DESCRIPTION OF THE DRAWINGS

The accompanying drawings, wherein like reference numerals are employed to designate like components, are included to provide a further understanding of secure CTI operation on a public network, are incorporated in and constitute a part of this specification, and illustrate embodiments of secure CTI operation on a public network that together with the description serve to explain the principles of secure CTI operation on a public network.

In the drawings:

FIG. 1 illustrates an embodiment of a client establishing communications with a CTI server by way of SOAP;

FIG. 2 illustrates an embodiment of a method of operating a computer telephony integration device over a public network;

FIG. 3 illustrates an embodiment of a computer telephony integration device; and

FIG. 4 illustrates an embodiment of a CTI communication network.

### DETAILED DESCRIPTION

Reference will now be made to embodiments of secure CTI operation on a public network, examples of which are illustrated in the accompanying drawings. Details, features, and advantages of secure CTI operation on a public network will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

CTI systems typically operate on a private network, such as a Local Area Network (LAN) or a Wide Area Network (WAN), to assure that they are not accessed or corrupted by the general public. Those private networks may interface to a public network, such as the Internet, through a firewall configured to provide various security functions such as filtering and address translation, to protect the private network from access or corruption by people outside of the organization that have access to the public network. The firewall may, for example, examine each packet received by the private network and determine whether to reject each packet or forward each packet to its intended recipient node within the private network. The firewall may also restrict the communication ports that may be used by messages.

CTI systems have an open architecture that allows flexibility, permitting CTI systems to be easily migrated to new types of applications that work with either public switched telephone network (PSTN) based systems or Internet Protocol (IP) based systems. CTI systems are generally scalable and can share computer telephony hardware with other applications, thus offering a cost effective solution for many telephony needs.

Communication on the CTI network may be performed, for example, by way of Remote Procedure Call (RPC) mechanisms. RPC mechanisms generally permit an application running in a node to request a service from an application running on another node in a network. Such RPC mechanisms are typically not suitable to pass information through a firewall because RPCs may include harmful information or may be transmitted by persons outside of the organization who should not have access. For example, RPC communications often utilize dynamic communications port numbers, thus not specifying through which port those communications should pass, but rather providing a range of ports through which the communications may pass. Moreover, an important aspect of a typical firewall is the ability to restrict which communication ports applications may use. To allow RPC traffic to pass through the firewall would thus require opening a range of port numbers to RPC communications. Such an opening of communication ports might expose the private network to intrusion or attack from the public network.

Solutions aimed at allowing RPC traffic to pass through a firewall have been suggested. Such solutions, however, are not supported consistently in network servers and so may not be available, and where available, may not provide a consistent solution. One such solution is to utilize a Virtual Public Network (VPN) in connection with the CTI system. A VPN is a secure network that operates on a public network. To maintain security, VPNs generally use tunneling protocols that transmit private information through a public network securely. Configuration of a VPN tunnel is generally complex, requiring a combination of custom software and manual installation for each node to be utilized on the VPN. That configuration may, moreover, have to be performed each time there is an upgrade to the VPN because VPNs typically operate with predefined data communication paths and user members. Thus, use of a VPN to securely pass CTI system information may be prohibitively time consuming, inflexible, and costly.

Recognizing that public networks, such as the Internet, are unsafe because they are open to the public and members of the public may intrude upon or attack a node on the public network, it would nonetheless be desirable to operate a CTI system on such a public network. Thus a secure implementation of a CTI system on a public network is provided herein. That secure implementation of a CTI system on a public network furthermore requires minimal or no change to an existing CTI infrastructure and minimal or no custom implementation, thus offering an attractive, cost effective alternative to existing CTI architectures with minimal time required to implement. Such a secure CTI system operating on a public network would permit, for example, call center operators utilizing the CTI system to work from home by accessing the CTI system over the Internet.

Call centers are a typical application in which CTI systems are used. Call centers are generally central locations through which high volumes of telephone calls are directed and which can simultaneously screen, forward and log those calls. Call centers are often used by mail order organizations and telemarketing companies.

Such a CTI system may operate on a public network utilizing a protocol that provides a high level of security and simple validation of information being passed to the CTI system as described herein. The Simple Object Access Protocol (SOAP) may be used to provide such a high level of security using CTI over a standard public network infrastructure, and is easily implemented between public and private networks.

SOAP is a minimalistic set of conventions for exchange of information in a decentralized, distributed environment. It is an Extensible Markup Language (XML) based protocol that is currently implemented on Hypertext Transfer Protocol (HTTP) and consists of four parts: an envelope that defines a framework for describing what is in a message and how to process it, a transport binding framework for exchanging messages using an underlying protocol, a set of encoding rules for expressing instances of application-defined data types, and a convention for representing remote procedure calls and responses. SOAP is defined by the W3C standard 1.2, which was submitted Sep. 24, 2002, and is available at www.w3.org.

XML provides a flexible way to create common information formats and share both the format and the data on a public or private network. As such, any user of a public network, for example, may collect XML formatted data from various nodes on the network and compare that data in a consistent way. XML version 1.0 is a second edition of XML that was recommended on Oct. 6, 2000 and is available from www.w3.org.

HTTP is an application level protocol that includes a set of rules for transferring files of information, such as text, graphic images, sound, and video, on the World Wide Web. HTTP version 1.1 is available at ftp.isi.edu, and is identified as request for comment 2616.

SOAP defines an RPC mechanism for XML formatted messages that can be sent using the HTTP protocol. Thus SOAP is suitable for use with existing public networks including the Internet. As SOAP messages are encoded as XML, a firewall is able to easily validate the SOAP message when it arrives at the firewall with filtering rules. A SOAP message is furthermore designed so that it may not contain a disguised payload by ensuring that the message content matches what is specified in the message header. Therefore, SOAP messages may be used to transmit CTI RPCs containing CTI information on both public and private networks.

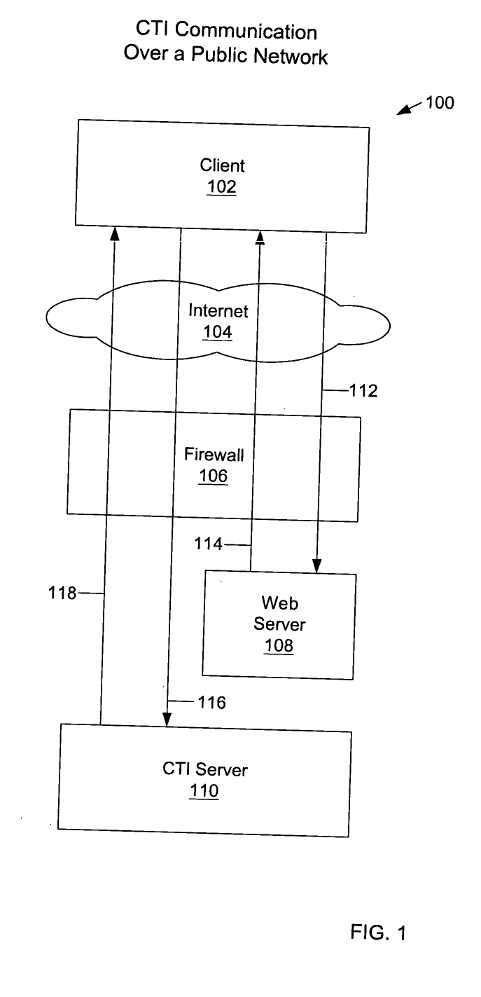

FIG. 1 illustrates an embodiment of a client establishing communications with a CTI server by way of SOAP 100. Initially, the client 102 is coupled to the Internet 104 and transmits a web request 112 over the Internet 104 to a web server 108. The web request 112 may, for example, be initiated by a web browser application executing in the client 102 and may include a request that the web server 108 return a web page desired by a user of the client 102. The request 112 may furthermore be directed to the web server 108 using a Uniform Resource Locator (URL) address for the web server 108 in one or more packets containing the request 112. A firewall 106 may receive the web request 112 from the Internet 104, confirm the appropriateness of the web request 112 and forward each packet of the web request 112 to the web server 108.

A web response 114 containing the web page requested and a CTI applet may be transmitted from the web server 108 to the client 102 through the firewall 106 and the Internet 104 in response to the web request 112. The CTI applet may be written in Java, for example. The CTI applet may implement SOAP in the client 102 once it is received by the client 102. The CTI applet may then transmit a CTI request 116 to a CTI server 110 over the Internet 104 and through the firewall 106 by way of a SOAP message and the CTI server 110 may respond to the CTI request 116 with a CTI response 118. Thus, the client 102 will have established communication and communicated information with a CTI server 110 that is running on a private network and is protected by a firewall, by way of a public network.

It should be noted that the firewall 106, web server 108 and CTI server 110 may be modules implemented in a single machine or two or more machines. Furthermore, SOAP communications may be executed at the web server 108 and communication may then occur between the web server 108 and the CTI server 110, with the web server 108 returning the requested CTI information to the client 102. Alternately, the SOAP communication may be executed at the CTI server 110 with or without the aid of the web server 108.

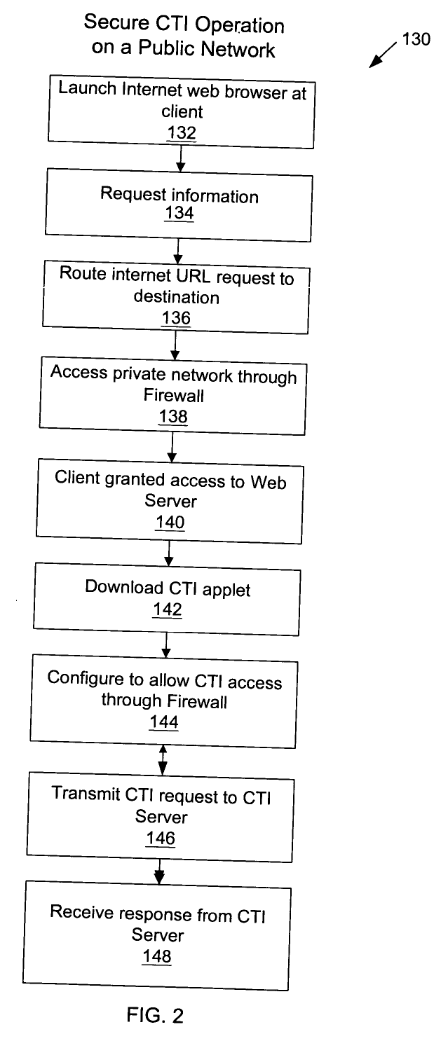

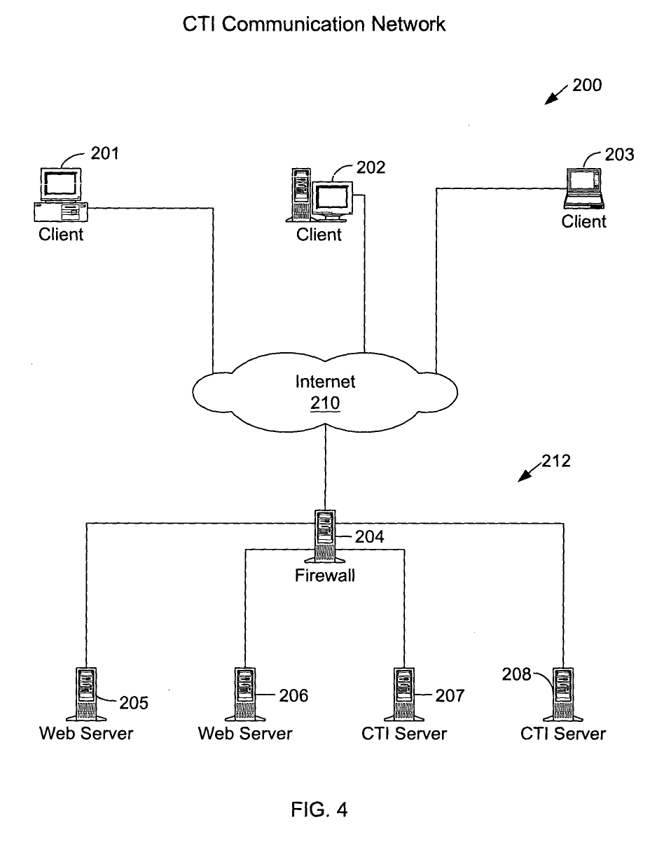

FIG. 2 illustrates an embodiment of a method of secure computer telephony integration operation on a public network 130. That method 130 may begin with the launching of a web browser 132 at a client node such as one of the clients 201-203 illustrated in FIG. 4. The web browser may then request retrieval of information, such as a web site, from another node on a private network coupled to a public network at 134. The launching of the web browser at 132 and request of the web page at 134 may be directed by a user of the client. The web site may be requested by entry of a URL that is cross-referenced to a numeric address of a node containing the desired web site by a server such as a location server on a public network. The request may then be routed to the node containing the desired information over the public network at 136.

At 138, that request may be intercepted by a firewall that has been arranged to protect the node containing the desired information from improper access. That firewall may be similar to the firewall 204 illustrated in FIG. 4. The firewall may assure that the request is being transmitted by an appropriate node and contain no improper data. At 140, the firewall may transmit the request to a web server such as the web servers 205 and 206 illustrated in FIG. 4.

At 142, the web server may return the requested information along with a CTI applet to the client. The CTI applet may be as described in connection with FIG. 1 and may implement SOAP on the requesting client when returned to the client to configure the client so that it may access a CTI server, such as those shown at 207 and 208 in FIG. 4, at 144.

At 146, the client may transmit another request to the CTI server, using SOAP so that the request may safely proceed through the firewall to the CTI server. At 148, the CTI communication is then transmitted to the client.

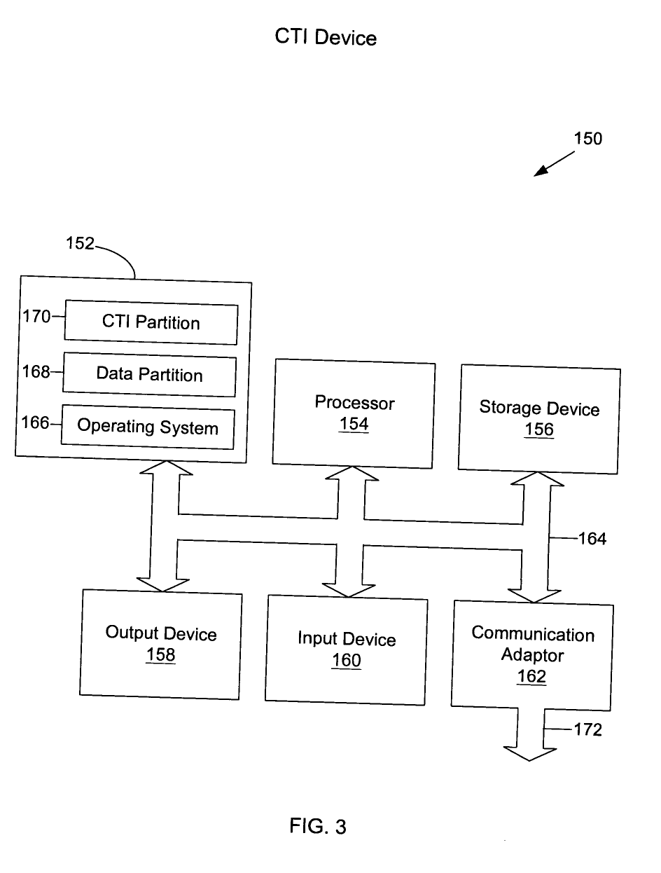

FIG. 3 illustrates an embodiment of a computer telephony integration device 150 for use with a public network. The CTI device 150 includes memory 152, a processor 154, a storage device 156, an output device 158, an input device 160, and a communication adaptor 162. It should be recognized that any or all of the components 152-162 of the CTI device 150 may be implemented in a single component. For example, the memory 152 and processor 154 might be combined in a state machine or other hardware based logic machine.

Communication between the processor 154, the storage device 156, the output device 158, the input device 160, and the communication adaptor 162 may be accomplished by way of one or more communication busses 164. It should be recognized that the CTI device 150 may have fewer components or more components than shown in FIG. 3. For example, if output devices 158 or input devices 160 are not desired, they may not be included with the CTI device 150.

The memory 152 may, for example, include random access memory (RAM), dynamic RAM, and/or read only memory (ROM) (e.g., programmable ROM, erasable programmable ROM, or electronically erasable programmable ROM) and may store computer program instructions and information. The memory 152 may furthermore be partitioned into sections including an operating system partition 166 wherein instructions may be stored, a data partition 168 in which data may be stored, and a CTI partition 170 in which instructions for implementing SOAP in a remote node and communicating with a remote SOAP enabled node may be stored. The CTI device 150 may also allow execution by the processor 154 of the instructions stored in the CTI partition 170. The data partition 168 may furthermore store data to be used during the execution of the program instructions such as, for example, information requested from the CTI device 150.

The processor 154 may execute the program instructions and process the data stored in the memory 152. In one embodiment, the instructions are stored in memory 152 in a compressed and/or encrypted format. As used herein the phrase, “executed by a processor” is intended to encompass instructions stored in a compressed and/or encrypted format, as well as instructions that may be compiled or installed by an installer before being executed by the processor 154.

The storage device 156 may, for example, be a magnetic disk (e.g., floppy disk and hard drive), optical disk (e.g., CD-ROM) or any other device or signal that can store digital information. The communication adaptor 162 may permit communication between the CTI device 150 and other devices or nodes coupled to the communication adaptor 162 at a communication adaptor port 172. The communication adaptor 162 may be a network interface that transfers information from nodes 201-208 on a network such as the network 200 illustrated in FIG. 4, to the CTI device 150 or from the CTI device 150 to nodes 201-208 on the network 200. The network in which the CTI device 150 operates may be a LAN, WAN, or the Internet or a combination thereof. It will be recognized that the CTI device 150 may alternately or in addition be coupled directly to one or more other devices through one or more input/output adaptors (not shown).

The CTI device 150 may also be coupled to one or more output devices 158 such as, for example, a monitor or printer, and one or more input devices 160 such as, for example, a keyboard or mouse. It will be recognized, however, that the CTI device 150 does not necessarily need to have any or all of those output devices 158 or input devices 160 to operate.

The elements 152, 154, 156, 158, 160, and 162 of the CTI device 150 may communicate by way of one or more communication busses 164. Those busses 164 may include, for example, a system bus, a peripheral component interface bus, and an industry standard architecture bus.

FIG. 4 illustrates an embodiment of a CTI communication network 200 in which embodiments of secure CTI communication over a public network may be implemented.

The clients 201-203 are nodes coupled to a public network such as the Internet 210. The firewall 204 interfaces to the Internet 210 and also interfaces to a private network 212 that includes web servers 205 and 206 and CTI servers 207 and 208. Thus, the firewall 204 may control access by clients or other nodes on the Internet 210 to the nodes 205-208 on the private network 212.

The network in which CTI communication is implemented may be a network of nodes such as computers, servers, voice over IP telephones or other, typically processor-based, devices interconnected by one or more forms of communication media. The communication media coupling those devices may include, for example, twisted pair wiring, co-axial cable, optical fibers and wireless communication methods such as use of radio frequencies.

Network nodes may be equipped with the appropriate hardware, software, or firmware necessary to communicate information in accordance with one or more protocols. A protocol may comprise a set of instructions by which the information is communicated over the communications medium. Protocols are, furthermore, often layered over one another to form something called a “protocol stack.” In one embodiment, the network nodes operate in accordance with a packet switching protocol referred to as the User Datagram Protocol (UDP) as defined by the Internet Engineering Task Force (IETF) standard b 6, Request For Comment (RFC) 768, adopted in August, 1980 (“UDP Specification”), and the Internet Protocol (IP) as defined by the IETF standard 5, RFC 791 (“IP Specification”), adopted in September, 1981, both available from “www.ietf.org.” In another embodiment, Transmission Control Protocol (TCP) as defined by the Internet Engineering Task Force (IETF) standard 7, Request For Comment (RFC) 793, adopted in September, 1981 (“TCP Specification”) may be used with IP. Stream Control Transmission Protocol (SCTP) may also be utilized in connection with an embodiment. SCTP is defined by IETF RFC 2960, published October 2000.

UDP is a network communications protocol that offers lesser services than TCP. For example, UDP may provide port numbers to distinguish different user requests and a checksum to verify that data arrived intact. UDP may not provide sequencing of the packets or retransmission of unreceived packets. After the packets are created, the IP layer transmits the packets across a network such as the Internet.

Nodes may operate as source nodes, destination nodes, intermediate nodes or a combination of those source nodes, destination nodes, or intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include signaling messages.

A client such as those shown at 201-203 in FIG. 4 may, for example, operate as a source node when transmitting a request and a destination node when receiving a response. A firewall such as shown at 204 in FIG. 4 may operate as an intermediate node, transferring information such as requests and responses from a client to a server or from a server to a client.

While the systems, apparatuses, and methods of signal detection have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

1. A method of communicating with a computer telephony integration server, comprising:
encoding the information in extensible markup language;
placing the encoded information in a simple object access protocol formatted message; and
transmitting the message by way of hypertext transfer protocol.

2. The method of claim 1, wherein the message is transmitted on a public network

3. The method of claim 1, wherein the message is transmitted on the Internet.

4. The method of claim 1, further comprising:
receiving the message at a firewall; and
transmitting the message from the firewall to a CTI server.

5. The method of claim 4, further comprising confirming the safety of the request at the firewall.

6. The method of claim 4, further comprising the firewall transmitting the message to the CTI server if the address of the node transmitting the message is in a database of nodes approved to access the CTI server.

7. The method of claim 4, further comprising the firewall not transmitting the message to the CTI server if the address of the node transmitting the message is not in a database of nodes approved to access the CTI server.

8. The method of claim 4, wherein the message is transmitted from the firewall to the CTI server on a private network.

9. A method of communicating with a computer telephony integration server, comprising:
transmitting a first request;
receiving and implementing simple object access protocol;
transmitting a second request for information from the computer telephony integration server utilizing simple object access protocol; and
receiving the information from the computer telephony integration server.

10. The method of claim 9, wherein the first request is transmitted over a public network.

11. The method of claim 10, wherein the first request is received by a firewall coupled to the public network and a private network and transmitted to a server in the private network.

12. The method of claim 11, wherein the second request is transmitted over the public network.

13. The method of claim 12, wherein the second request is received by the firewall and transmitted over the private network to the computer telephony integration server.

14. The method of claim 10, wherein the firewall confirms the safety of the request.

15. The method of claim 10, wherein the firewall confirms the appropriateness of a node transmitting the first request.

16. The method of claim 9, wherein the first request is a request for information from the computer telephony integration server.

17. The method of claim 9, wherein the first request is a request for information from a web server that includes information to be received from a computer telephony integration server.

18. The method of claim 9, wherein the second request is encoded in extensible markup language.

19. The method of claim 9, wherein the second request is formatted in one or more simple object access protocol formatted packets.

20. The method of claim 9, wherein the second request is transmitted by way of hypertext transfer protocol.

21. A computer telephony integration device, comprising:
a communication adaptor to couple to a public network;
a processor coupled to the communication adaptor to:
encode a request in extensible markup language;
place the encoded request in a simple object access protocol formatted message; and
transmit the message by way of hypertext transfer protocol through the communication adaptor.

22. The computer telephony integration device of claim 21, wherein the processor places the request in a plurality of packets.

23. An article of manufacture, comprising:
a computer readable medium having stored thereon instructions which, when executed by a processor, cause the processor to:
encode a request in extensible markup language;
place the encoded request in a simple object access protocol formatted message; and
transmit the message by way of hypertext transfer protocol through the communication adaptor.

24. The article of manufacture of claim 23, wherein the instructions cause the processor to place the request in a plurality of packets.

25. An application server, comprising:
a communication adaptor to couple to a public network;
a processor coupled to the communication adaptor to:
receive a request for execution of an application through the communication adaptor;
encode a request in extensible markup language;
place the encoded request in a simple object access protocol formatted message; and
transmit the message by way of hypertext transfer protocol through the communication adaptor.

26. The application server of claim 25, wherein the processor is further to receive additional requests for execution of the application and to execute those requests for execution based on a schedule.
